(19) United States
(12) Patent Application Publication
(10) Pub. No.: US 2025/0233224 A1
(43) Pub. Date: Jul. 17, 2025

(54) BATTERY MODULE WITH COOLANT FLOW CONTROL

(71) Applicant: GM GLOBAL TECHNOLOGY OPERATIONS LLC, Detroit, MI (US)

(72) Inventors: Chinmaya Patil, South Lyon, MI (US); John P. Spicer, Plymouth, MI (US); Miguel Arturo Saez, Clarkston, MI (US); Madhusudan Raghavan, West Bloomfield, MI (US); Christopher D Cogan, Clarkston, MI (US); Ronald Wahl, Oakland, MI (US); Jeff Jadike, Washington Twp., MI (US)

(73) Assignee: GM GLOBAL TECHNOLOGY OPERATIONS LLC, Detroit, MI (US)

(21) Appl. No.: 18/409,864

(22) Filed: Jan. 11, 2024

(51) Int. Cl. H01M 10/613; B60L 50/64; H01M 10/48; H01M 10/6568; H01M 50/249

(52) U.S. Cl. CPC H01M 10/613; B60L 50/64; H01M 10/486; H01M 10/6568; H01M 50/249; H01M 2220/20

(57) ABSTRACT

A battery module including a plurality of battery cells configured for storing and supplying electrical power, a cell holder configured for supporting the battery cells, a preformed insert including a potting material shaped to define a plurality of coolant channels for the battery cells, and a flow control system operable for controlling a coolant flow through the coolant channels.

### INTRODUCTION

The present disclosure relates to cooling battery cells included within a battery module, such as but not necessarily limited to cooling battery cells configured for storing and supplying electrical power for a vehicle.

A rechargeable energy storage system (RESS) may be configured for storing and supplying electrical power for a wide variety of applications, with one of the more common types of RESSs including a plurality of battery cells arranged into one or more battery modules. Such an RESS may be included onboard a vehicle to store and supply electrical power for a main or a high voltage (HV) bus and/or an auxiliary or a low voltage (LV) bus. Because the battery cells tend to generate heat when storing and supplying electrical power, it may be advantageous for the associated battery module to be operate with a cold plate or other external element of a cooling system to conduct thermal energy away from the battery cells. Such a cooling system may include a static epoxy filler or other solidifying fluid to provide fixed thermal pathways of immovable material to facilitate conducting thermal energy away from the battery cells. The immovability of such fillers may operate to essentially provide a type of stationary heat sink whereby heat generated with the battery cells may conduct through the static material in an attempt to dissipate the attendant thermal energy to the cold plate or other external cooling element, which may be relatively inefficient.

### SUMMARY

One aspect of the present disclosure relates to a battery module configured for dissipating heat away from battery cells in a relatively efficient manner, such as by leveraging thermodynamic benefits of a moving coolant flow to conduct or otherwise thermally transfer heat away from the battery cells.

One aspect of the present disclosure relates to a battery module. The battery module may include a plurality of battery cells configured for storing and supplying electrical power, a cell holder configured for supporting the battery cells, a preformed insert disposed relative to the cell holder and the battery cells, optionally with the preformed insert including a potting material shaped to define a plurality of coolant channels for the battery cells, and a flow control system operable for controlling a coolant flow through the coolant channels.

The flow control system may include a plurality of flow diverters disposed within the potting material, optionally with the flow diverters configured for metering the coolant flow through a respective one of the coolant channels.

The flow diverters may be configured for contracting from a nominal state to a smaller state in response to a coolant temperature of the coolant flow thereat surpassing a nominal temperature threshold.

The flow diverters may be configured for contracting from a nominal state to a minimal state in response to a coolant temperature thereat surpassing a nominal temperature threshold by a predefined amount.

The nominal state may result in the flow diverters obstructing a greater portion of the coolant channels than when in the minimal state such that the nominal state restricts the coolant flow more than the minimal state.

The preformed insert may include a plurality of cell cavities fluidly interconnected with the coolant channels, optionally with the cell cavities shaped within the potting material to receive a respective one of the battery cells.

The coolant channels may be formed with a spiral shape around the cell cavities, wherein the spiral shape directs the coolant flow in a circular manner from top to bottom or from bottom to top of a respective one of the cell cavities.

The flow control system may include a coolant container configured for enclosing the preformed insert and the battery cells within a sealed enclosure, optionally with the sealed enclosure operable for directing the coolant flow through the coolant channels and around the battery cells to provide immersive cooling.

The coolant container may include a pressure release valve configured for releasing the coolant flow to an exterior of the sealed enclosure in response to a pressure within the sealed enclosure surpassing a pressure threshold.

The preformed insert may include a plurality of thermal channels for the battery cells, wherein the thermal channels are configured for retaining a thermal fluid separately from the coolant flow when a coolant temperature of the coolant flow is less than a thermal threshold and for releasing the thermal fluid into the coolant flow when the coolant temperature surpasses the thermal threshold.

The flow control system may include a flow manifold operable for directing a coolant input having a coolant to the coolant channels to produce the coolant flow therethrough.

The flow control system may include an input and an output for each respective one of the coolant channels and a flow director operable for selectively metering the coolant through the inputs and outputs, and thereby, the coolant flow through the respective coolant channel.

The flow control system may include a plurality of temperature sensors disposed relative to the battery cells and/or the coolant channels, optionally with the flow director operable for metering the coolant based on temperatures measured with the temperature sensors.

One aspect of the present disclosure relates to a battery module. The battery module may include a plurality of battery cells configured for storing and supplying electrical power, a preformed insert including a potting material shaped to define a plurality of cell cavities for retaining the battery cells and a plurality of cooling channels for directing a coolant flow relative to the cell cavities, a coolant container configured for enclosing the preformed insert and the battery cells within a sealed enclosure, and an immersive flow control system operable for cycling a coolant through the coolant channels and the coolant container to immersively cool the battery cells.

The immersive flow control system may include a plurality of flow diverters disposed within the coolant channels, optionally with the flow diverters configured for expanding and contracting based on a coolant temperature of the coolant flow thereat.

The flow diverters may be configured for contracting from a nominal state to a minimal state in response to a coolant temperature thereat surpassing a nominal temperature threshold by a predefined amount, optionally with the nominal state resulting in the flow diverters obstructing a greater portion of the coolant channels than when in the minimal state.

The coolant channels may be formed with a spiral shape that directs the coolant flow in a circular manner from top to bottom or from bottom to top of a respective one of the cell cavities.

One aspect of the present disclosure relates to a vehicle including an electric motor configured for converting electrical power to mechanical power suitable for use in propelling the vehicle and a rechargeable energy storage system (RESS) having one or more energy modules configured for storing and supplying the electrical power. The energy modules may respectively include a plurality of energy cells configured for storing and supplying electrical power, a preformed insert including a potting material shaped to define a plurality of cell cavities for retaining the energy cells and a plurality of cooling channels for directing a coolant flow relative to the cell cavities, a coolant container configured for enclosing the preformed insert and the energy cells within a sealed enclosure, and an immersive flow control system operable for cycling a coolant through the coolant channels and the coolant container to immersively cool the energy cells.

The energy modules each may include a busbar configured for electrically interconnecting the energy cells thereof, optionally with the busbars respectively connected to a portion of the energy cells above the preformed insert and within the coolant container such that the busbars are immersively cooled.

The immersive flow control system may include a plurality of flow diverters disposed within the coolant channels, optionally with the flow diverters configured for expanding and contracting based on a coolant temperature of the coolant flow thereat such that the flow diverters contract from a nominal state to a minimal state in response to a coolant temperature thereat surpassing a nominal temperature threshold by a predefined amount and thereafter expand back to the nominal state upon the coolant temperature dropping below the nominal temperature threshold.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a vehicle in accordance with one non-limiting aspect of the present disclosure.

FIG. 2 illustrates a partial exploded view of a battery module in accordance with one non-limiting aspect of the present disclosure.

FIG. 3 illustrates a partial cutaway perspective view of a preformed insert in accordance with one non-limiting aspect of the present disclosure.

FIG. 4 illustrates a perspective view of a battery module in accordance with one non-limiting aspect of the present disclosure.

FIG. 5 illustrates a schematic side view taken from FIG. 4 to illustrate a preformed insert having a divided configuration in accordance with one non-limiting aspect of the present disclosure.

FIG. 6 illustrates a cross-sectional view taken from FIG. 4 to illustrate a preformed insert having a unitary configuration in accordance with one non-limiting aspect of the present disclosure.

FIG. 7 illustrates a cross-sectional view taken from FIG. 4 to illustrate a preformed insert having a unitary configuration with flow diverters in accordance with one non-limiting aspect of the present disclosure.

FIG. 8 illustrates a cross-sectional view taken from FIG. 4 to illustrate a preformed insert having a unitary configuration with spiral channels in accordance with one non-limiting aspect of the present disclosure.

FIG. 9 illustrates a side schematic view of the spiral channels directing the coolant flow relative to a surface of a respective one of the battery cells in accordance with one non-limiting aspect of the present disclosure.

FIG. 10 illustrates a perspective schematic view of the spiral channels directing the coolant flow relative to a surface of a respective one of the battery cells in accordance with one non-limiting aspect of the present disclosure.

FIG. 11 illustrates a flowchart of a method for manufacturing a battery module in accordance with one non-limiting aspect of the present disclosure.

### DETAILED DESCRIPTION

As required, detailed embodiments of the present disclosure may be disclosed herein; however, it may be understood that the disclosed embodiments may be merely exemplary of the disclosure that may be embodied in various and alternative forms. The figures may not be necessarily to scale; some features may be exaggerated or minimized to show details of particular components. Therefore, specific structural and functional details disclosed herein may need not to be interpreted as limiting, but merely as a representative basis for teaching one skilled in the art to variously employ the present disclosure.

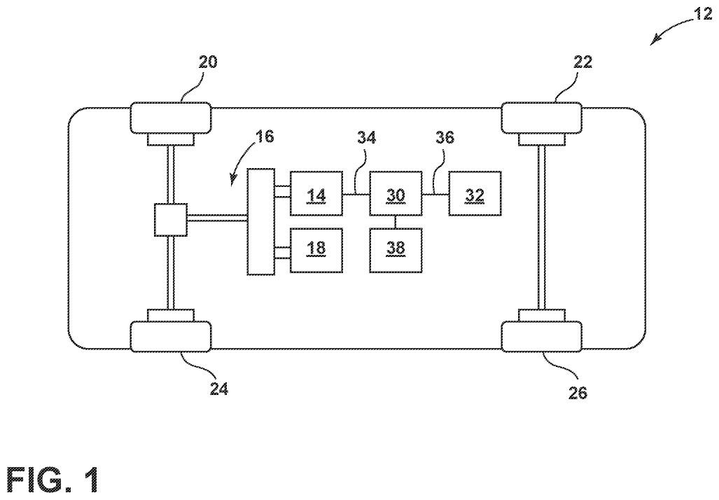

FIG. 1 illustrates a vehicle 12 in accordance with one non-limiting aspect of the present disclosure. The vehicle 12, which may be interchangeable referred to as an electric vehicle 12, may include a traction motor 14 operable for converting electrical power to mechanical power for purposes of performing work, such as for mechanically powering a drivetrain 16 to propel the vehicle. The vehicle 12 is illustrated as a hybrid type due to the powertrain 16 optionally including an internal combustion engine (ICE) 18 for generating mechanical power. The vehicle 12 may alternatively omit the electric motor 14 and instead be solely propelled with the ICE 18. The powertrain 16 may include componentry to facilitate conveying rotative force from the traction motor 14 and/or the ICE 18 to one or more of the wheels 20, 22, 24, 26. The vehicle 12 may include a rechargeable energy storage system (RESS) 30 to store and supply electrical power for the traction motor 12 and/or other components, systems, etc. 32 onboard the vehicle 12, such as via a first bus 34 (e.g., main or HV bus) and a second bus 36 (e.g., auxiliary or LV bus). The vehicle 12 may include a vehicle controller 38 to facilitate monitoring, controlling, measuring, and otherwise directing operation, performance, etc. onboard the vehicle 12, which may include performing measurements, taking readings, or otherwise collecting data to facilitate operations. The vehicle controller 38 may include additional controllers (not shown), with the operations associated therewith optionally being undertaken according to one or more processors executing corresponding non-transitory instructions stored one or more computer-readable storage mediums.

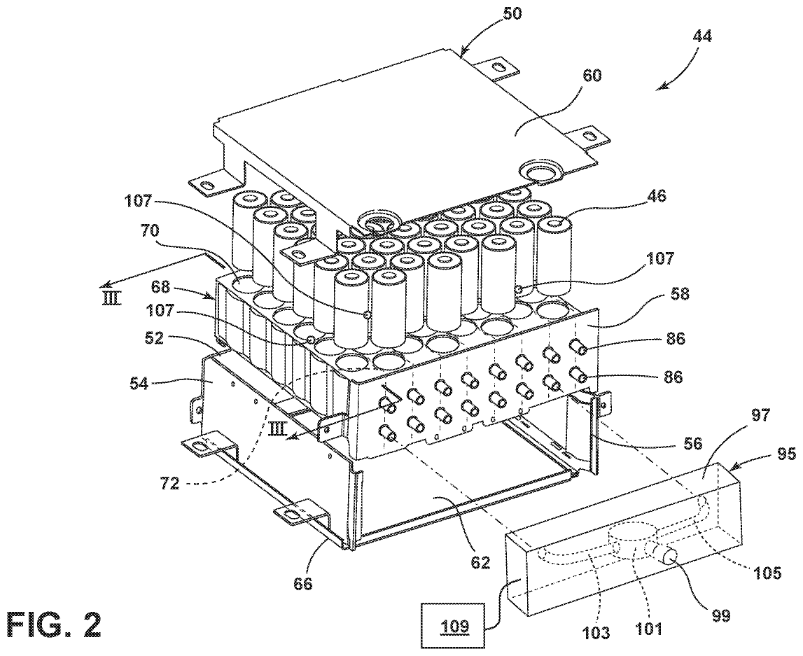

FIG. 2 illustrates a partial exploded view of the battery module 44 in accordance with one non-limiting aspect of the present disclosure. The battery module 44 may be included as a part of the RESS 30 to house a plurality of battery cells 46, which may in turn be operable for storing and supplying electrical power. The RESS is shown with respect to including a single battery module 44 for presentation simplicity as the present disclosure fully contemplates the RESS 30 including additional battery modules 44, including battery modules 44 having more or less than the illustrated quantity of battery cells 46. The battery module 44 may include additional componentry for electrically interconnecting the battery cells 46 to each other and/or other systems onboard the vehicle 12. The battery cells 46 may be comprised of a wide variety of components operable for storing and supplying electrical power. The battery cells 46 may include a lithium-ion material or other material chemistry suitable for storing and supplying electrical power, optionally with some of the battery cells 46 having mixed or different chemistries than some of the other battery cells 46. The use of battery cells 46, however, is presented for non-limiting purposes as the present disclosure fully contemplates the battery cells 46 being other types of energy cells capable of storing and/or supplying electrical power, such as but not necessarily limited to energy cells comprised partially or entirely of capacitors, supercapacitors, fuel cells, and/or other types of energy components.

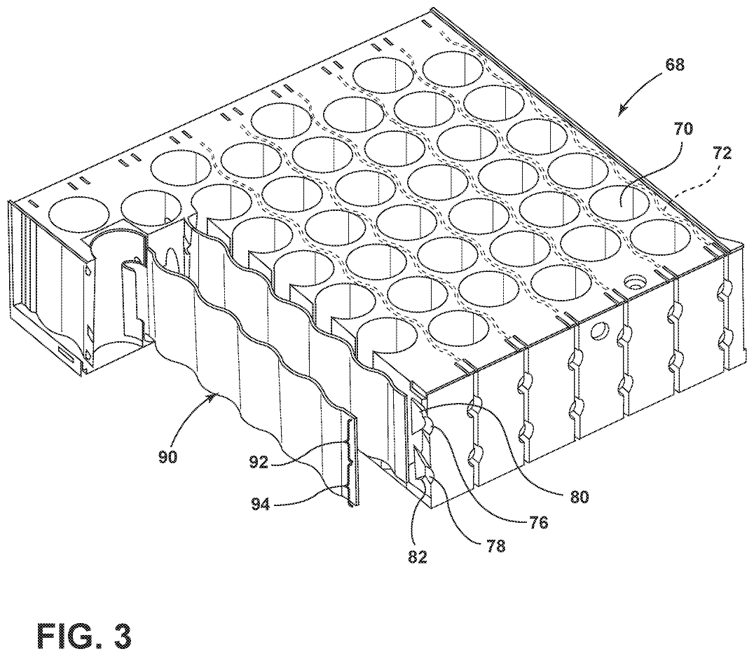

The battery module 44 may include a cell holder 50 configured for supporting the battery cells 46. The cell holder 50 may be formed as a rigid construction, such as out of a plurality of stamped or molded materials assembled into a housing or other structure suitable for enclosing the battery cells 46. The cell holder 50 is shown for non-limiting purposes as including four side pieces 52, 54, 56, 58 and oppose top and bottom pieces 60, 62 that may be interconnected, welded, fastened, or otherwise attached to each other. The bottom piece 62 have include underside resting against or otherwise cooperating with a cold plate 66 or other element of a cooling system (not shown). One aspect of the present disclosure relates to a preformed insert 68 being included within the battery module 44. The preformed insert 68 may be operable to facilitate conducting thermal energy away from battery cells 46 without having to pour a filler or other solidifying material into an associated battery module or otherwise undertake labor and time consuming manufacturing processes. As shown in the partial cross-sectional perspective view of FIG. 3, the preformed insert 68 may be formed out of a potting material shaped to define cavities 70 for receiving the battery cells 46 and coolant channels 72 for cycling a dielectric or other suitable coolant relative to the battery cells 46. The battery cells 46 may be press-fit or otherwise inserted within the cavities 70 and the coolant may thereafter be cycled through the coolant channels 72 to conduct thermal energy away from the battery cells 46. The capability to cycle coolant through the coolant channels 72 (which are not individually labeled and are instead shown with representative dashed lines for presentation simplicity) may be advantageous relative to thermal pathways having fixed or immovable fillers due to the cycling of coolant tending to provide greater thermal distribution and efficiency.

The preformed insert 68 may include the cell cavities 70 arranged according to a plurality of rows and columns, optionally with the coolant channels 72 in each row being fluidly interconnected. The preformed insert 68 may include a coolant inlet 76 and a coolant outlet 78 for each of the coolant channels 72, which may optionally include a cone or other shaped expansion element 80, 82 for dispersing coolant therethrough. The preformed insert 68 may optionally include a coolant ribbon 90 disposed within one or more of the coolant channels 72. The coolant ribbons 90 may be rigid structures for defining coolant passageways for coolant to flow through the coolant channels 72. The coolant ribbons 90 may be divided into an upper section 92 and a lower section 94 such that coolant fluid may be delivered through a respective one of the coolant inlets 76 for communication through the upper section 92, with the coolant thereafter traveling to a rearward end of the associated coolant ribbon 90 whereat it may reverse direction to flow back towards a respective coolant outlet 78 positioned proximate to the associated lower section 94. The material used to form the preformed insert 68 may be comprised of a thermally conductive material having a closed-cell foam structure or other type of material suitable for thermally conducting energy away from the battery cells 46. The potting material may be semi-rigid or less rigid than the housing 50 and/or the coolant ribbons 90. The potting material may be sufficiently dense and/or stiff to facilitate press-fitting with the battery cells 46 and/or otherwise supporting the battery cells 46 in the manner contemplated herein.

Returning to FIG. 2, the coolant inlets and outlets 76, 78 may cooperate with inlet and outlet coolant ports 86, 88 included within the cell holder 50 to facilitate fluidly connecting the coolant inlets and outlets 80, 82 with a flow control system 95. The flow control system 95 may include a flow manifold 97 operable for directing a coolant input 99 having a coolant to the coolant channels 72 for purposes of producing the coolant flow therethrough. The flow control system 95 may include a flow director 101 operable for selectively metering the coolant through the inputs and outputs, and thereby, the coolant flow through the respective coolant channel. The flow director 101 is shown for presentation simplicity as including two conduits 103, 105 for fluidly interconnecting with the inlets and outlets 76, 78 of the preformed insert 68 as the present disclosure fully contemplates the flow director 101 including additional conduits, optionally with separate conduits being provided for each of the inlets and outlets 76, 78. The flow control system 95 may include a plurality of temperature sensors 107 disposed relative to the battery cells 46 and/or the coolant channels 72. The flow director 101 may be operable for metering the coolant exchange with the inputs and outputs 76, 78 based on temperatures measured with the temperature sensors 107. While a few of the temperature sensors 107 are shown for presentation simplicity, a greater variety of temperature sensors may be utilized to facilitate individually measuring temperatures at the battery cells 46, within the coolant channels 72, and/or elsewhere within the module 44. The flow control system 95 may include a flow controller 109 operable for using the temperature measurements, optionally with other vehicle related metrics, e.g., state of charge (SOC), range, motor demand, etc., to correspondingly adjust the rate, the amount, and/or other metering options for the coolant cycling through the coolant channels 72. This capability to selectively meter the coolant flow may be beneficial in enabling the flow control system 95 to influence cooling of the battery cells in a manner that may be tailored to maximizing performance, efficiency, longevity, etc.

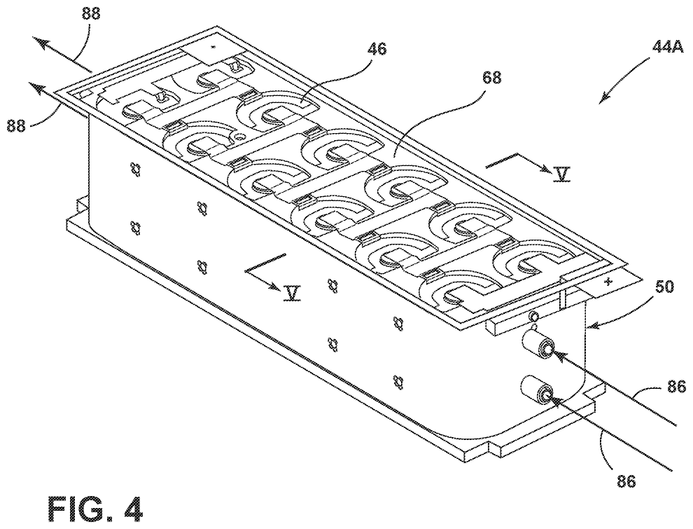

FIG. 4 illustrates a perspective view of a battery module 44A in accordance with one non-limiting aspect of the present disclosure. The battery module 44A may be similar to that described above with respect to including a cell holder 50 and a plurality of battery cells 46 position within a preformed insert 68. The battery module 44A is shown to include less battery cells 46 in the battery module 44 described above in order to demonstrate advantageous capabilities of the present disclosure to support a modular construction whereby multiples of the battery modules 44A may be joined together to form the RESS 30, such as with multiple modules being operable together in series and/or in parallel. The capability to selectively interconnect multiple battery modules 44A may be advantageous in tailoring the size, capacity, etc. of the RESS 30 to the vehicle and/or other device employing the use thereof. One aspect of the present disclosure contemplates the preformed insert 68 having differing configurations depending on a desired manner for cycling coolant through the coolant channels 72. The capability to cycle coolant through the coolant channels 72 may be advantageous in providing an immersive type of cooling environment whereby a coolant may be cycled relative to the battery cells 46, and optionally in contact with the battery cells 46, so as to optimize thermal conductivity and cooling. While the battery module 44A may include the inlets and outlets 86, 88 to the coolant channels 72 in the manner described above, the battery module 44A, as an exemplary alternative, may include the coolant inlets 86 at one end of the cell holder 50 and the coolant outlets 88 at the other end such that coolant flows in one direction from front to back through the preformed insert 68. As one skilled in the art may appreciate, the capability to cycle coolant, and thereby improve cooling over static or immovable fillers and heat sinks, may be advantageous in limiting operating temperatures for the RESS 30, which may in turn improve battery cell 46 performance, efficiency, longevity, etc.

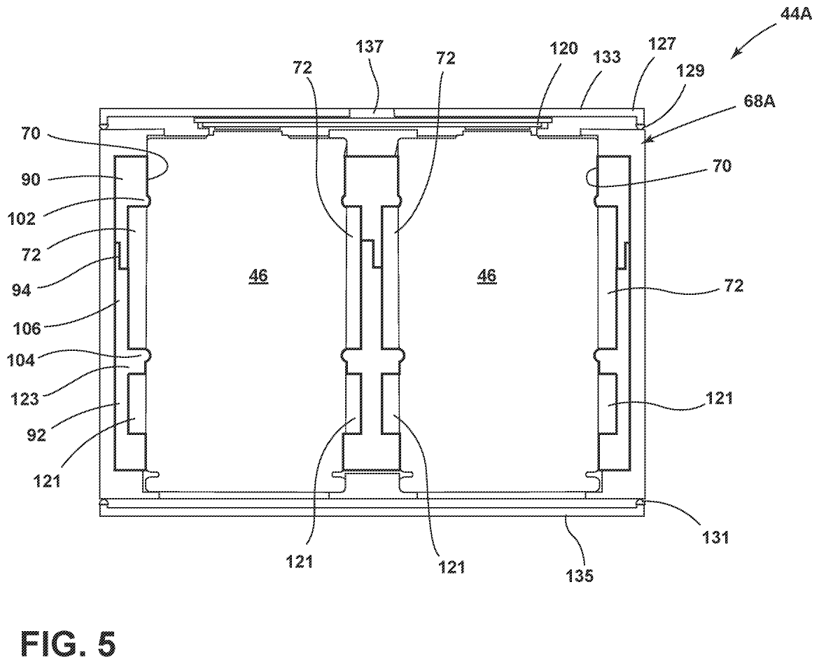

FIG. 5 illustrates a schematic side view taken from FIG. 4 to illustrate a preformed insert 68A having a divided configuration in accordance with one non-limiting aspect of the present disclosure. The divided configuration may correspond with the preformed insert 68A having a two-piece construction, with an upper part 90 preformed separately from a lower part 92 and an interlock 94 configured for attaching the upper part 90 to the lower part 92. The interlock 94 may include features suitable for sealing, connecting, or otherwise attaching the upper lower parts together such that coolant flowing through the respective coolant channels 72 may be retained therein. The interlock 94 may be operable to permit the lower part 92 to be inserted within the cell holder 50 so that the battery cells 46 may be inserted into respective one of the battery cavities 70 whereafter the upper part 90 may be assembled thereover. The interlock 94 may also be operable to permit the lower part 90 to be inserted within the cell holder 50 so that the upper part 90 may be assembled thereover whereafter the battery cells 46 may be fitted into the cell cavities 70 after the preformed insert 68A is assembled. The cell cavities 70 may include an upper end 98 proximate a top of the battery cells 46 and a lower end 100 proximate a bottom of the battery cells 46. The preformed insert 68A may include upper and lower protuberances 102, 104 configured to provide an upper interference fit between the upper end 98 and the top of the battery cells 46 and a lower interference fit between the lower end 100 and the middle of the battery cells 46. The interference fits may be operable for retaining coolant within the respective coolant channels 72. The upper and lower ends 98,100 of the cell cavities 70 may be narrower than a middle portion 106 such that the middle portion 106 may be used to define the respective coolant channels 72. The preformed potting material forming the preformed insert 68A may be shaped to at least partially or entirely surround the battery cells 46 laterally such that the cell cavities 70 may be interspersed relative to the coolant channels 72. The cell cavities 70 may interconnect with or form part of the coolant channels 72 such that the coolant cycling through the coolant channels 72 may physically contact the sides of the battery cell 46 before passing through a tunneled section connecting to another one of the cell cavities 70. A busbar or other circuit componentry 120 may be included for electrically interconnecting the battery cells 46 with each other.

The divided configuration may additionally include a plurality of thermal channels 121 preformed in the potting material to be operable independently of the coolant channels 72. The thermal channels 121 may be separated from the coolant channels 72 with a divider or other feature 123 suitable for providing an interference fit, gasket, O-ring, or other seal capable of isolating the coolant flow from a thermal fluid included within the thermal channels 121. The thermal channels 121 may be configured for retaining the thermal fluid independently from the coolant flow when a coolant temperature of the coolant flow is less than a thermal threshold, which, for example, may be based on temperatures associated with a thermal event. The divider or other componentry 123 used to seal off the coolant channels 72 from the thermal channels 121 may be configured to change shape, disintegrate, or otherwise alter its configuration or material construction automatically upon the coolant temperature thereat surpassing the thermal threshold. Upon such an event, the divider 123 may be configured for releasing the thermal fluid into the coolant flow in an attempt to provide additional assistive cooling. The thermal fluid may have cooling properties differing from the coolant, and optionally, additional additives for providing chemical suppressants that may be assistive in providing additional cooling beyond that provided with the coolant. The divider 123 may be a sacrificial type of component whereby the releasing of the thermal fluid may be irreversible insofar as the divider thereafter being unable to fluidly isolate the thermal channels 121 from the coolant channels 72 associated therewith.

The module 44A may optionally include a coolant container 127 configured for enclosing the preformed insert 68A and the battery cells 46 within a sealed enclosure. The flow control system 95 may include the coolant container 127 to facilitate additionally cycling the coolant outside of the coolant channels 72 to provide additional immersive cooling of the battery cells 46. The coolant container 127 may be provided with sealing joints 129, 131 between the top and bottom pieces 60, 62 of the cell holder 50 or in the illustrated manner with a container top piece 133 and a container bottom piece 135 being used in place thereof or added thereover. The coolant container 127 may be formed and configured in his manner for enclosing the preformed insert 68A and the battery cells 46 within the sealed enclosure so the coolant may be cycle through the coolant channels 72 and auxiliary channels or spaces defined related to the preformed insert 68A, the busbar 120, and other portions of the module 44A within the sealed enclosure. The flow director 101 may optionally be configured for metering the coolant through the auxiliary spaces independently of the cooling channels, such as via inlets and outlets associated therewith (not labeled). The coolant container 127 may include a pressure release valve 137 configured for releasing the coolant flow to an exterior of the sealed enclosure in response to a pressure within the sealed enclosure surpassing a pressure threshold. The pressure relief valve 137, for example, may be configured to automatically open a valve or release itself from the container top piece when the pressure threshold is exceeded.

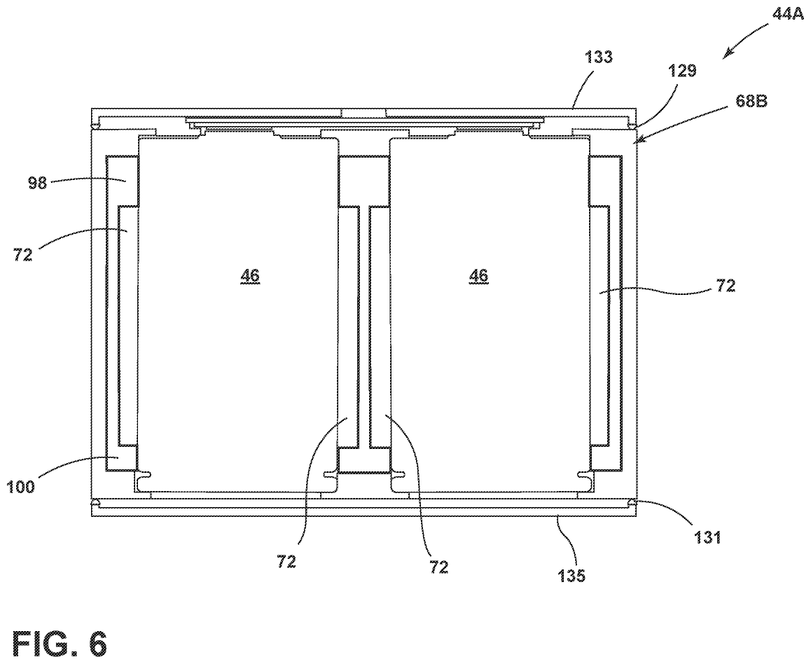

FIG. 6 illustrates a cross-sectional view taken from FIG. 4 to illustrate the preformed insert 68B having a unitary configuration in accordance with one non-limiting aspect of the present disclosure. The unitary configuration may be characterized by the preformed insert 68B insert having one-piece construction. While the present disclosure contemplates the unitary configuration including the thermal channels 121, the illustrated configuration illustrates the thermal channels 121 being omitted in order to expand or provide larger cross-sectional areas for the coolant channels 72. The top and bottom container pieces 133, 135 may be similarly included with the container seals 129, 131 so that coolant may be cycle through the coolant channels 72 and on the auxiliary spaces to provide immersive cooling. Because of the immersive cooling, i.e., the use of the coolant outside of the coolant channels 72, a fit between the upper and lower ends of the preformed insert and the respective battery cell 46 may permit coolant to pass therethrough, which may ease manufacturing of the preformed insert 68B and ease insertion of the battery cells 46 within the cell cavities 70. In the event it may be desirable to separate the coolant channels 72 from the auxiliary spaces, seals (not shown) may be used to provide an upper interference fit between the upper end 98 and the top of the battery cells 46 and a lower interference fit between the lower end 100 and the bottom of the battery cells 46. The seals may be formed out of rubber or other material different from the potting material and used in place of the above-described upper and lower protuberances to ameliorate tolerancing requirements, forming controls, and/or other processes needed to form the protuberances.

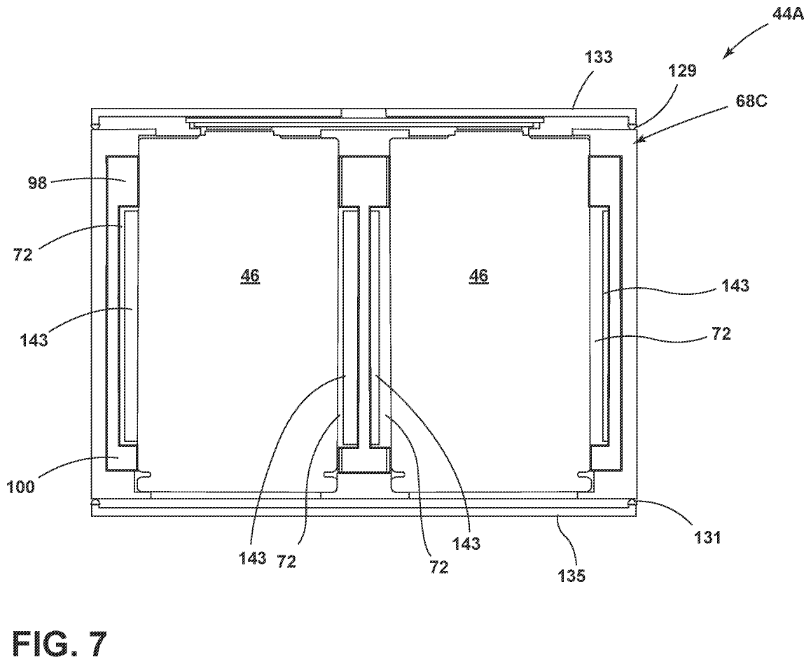

FIG. 7 illustrates a cross-sectional view taken from FIG. 4 to illustrate the preformed insert 68C having a unitary configuration with flow diverters 143 in accordance with one non-limiting aspect of the present disclosure. The flow diverters 143 may be part of the flow control system 95 and disposed within the potting material for metering the coolant flow through a respective one of the coolant channels 72. The flow diverters 143 may be configured for contracting from a nominal state to a smaller state in response to a coolant temperature of the coolant flow thereat surpassing a nominal temperature threshold. The flow diverters 143 may thereby be configured for contracting from a nominal state to a minimal state in response to a coolant temperature thereat surpassing a nominal temperature threshold by a predefined amount such that the nominal state results in the flow diverters 143 obstructing a greater portion of the coolant channels 72 than when in the minimal state such that the nominal state restricts the coolant flow more than the minimal state. The flow diverters 143 may be configured in this manner to act as temperature driven components capable of changing their shape and size or size depending on temperatures relative thereto. This capability to perform such self-adjustments may be beneficial in enabling the flow diverters 143 to individually adjust metering of the coolant cycling therethrough without requiring instructions or controls from the flow controller. As illustrated, this capability may result in some of the flow diverters 143 having differing sizes relative to other ones of the flow diverters 143 depending on respective temperature differentials thereat.

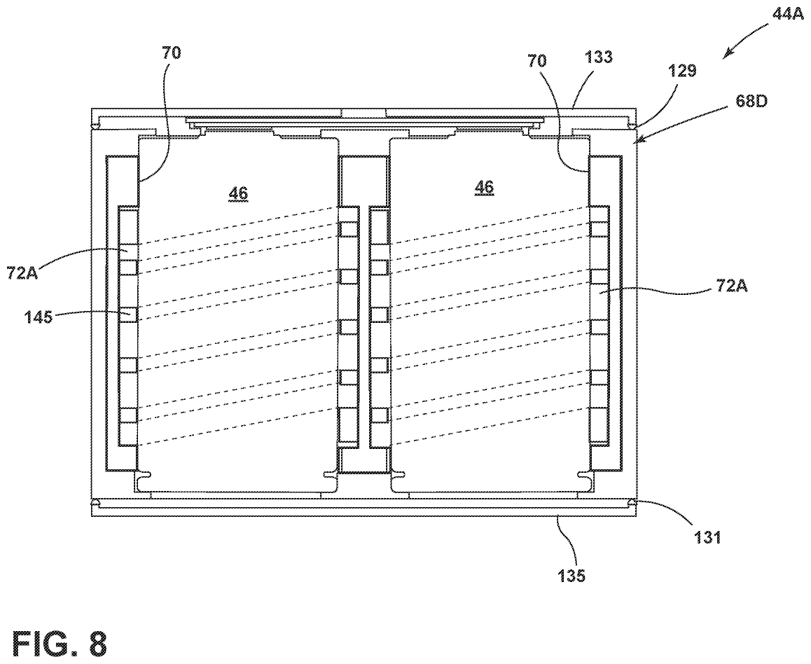

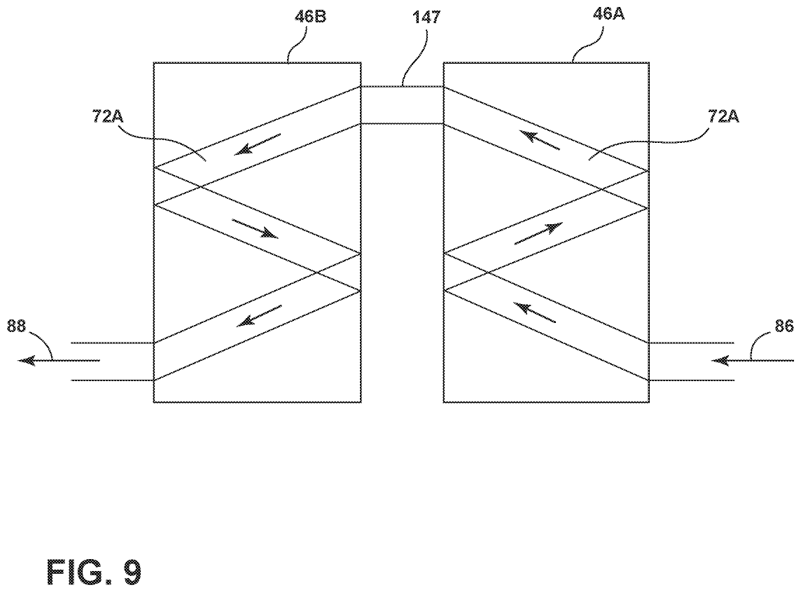

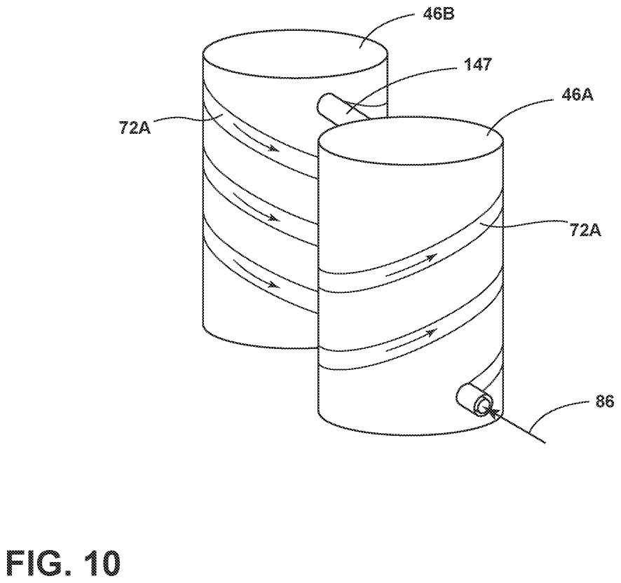

FIG. 8 illustrates a cross-sectional view taken from FIG. 4 to illustrate the preformed insert 68D having a unitary configuration with spiral channels 72A in accordance with one non-limiting aspect of the present disclosure. The spiral channels 72A may be configured for cycling coolant relative to the battery cells 46 in a circular manner whereby the coolant flows from top to bottom or from bottom to top of respective one of the cell cavities. The spiral or circular motion of the coolant may be beneficial in providing a convective type of action operable to facilitate cooling by directing the coolant around the battery cells 46 through multiple loops or windings included with the potting material. The loops or windings may correspond with recesses carved within the cell cavities relative to other bumps 145 such that from top to bottom portions of the potting material may be intermittently pressed against or in close proximity to the battery cells 46. The spiral channels 72A may optionally include seals, protuberances, or other elements to facilitate sealing the bumps 148 against the respective battery cells 46 for purposes of maintaining the desired directionality of the coolant flow. The present disclosure, however, fully contemplates omitting the seals or the seals being unnecessary as the spiraling action of the coolant may still be achieved even if some of the coolant is able to pass between the bumps 148 and the battery cells 46. FIG. 9 illustrates a side schematic view of the spiral channels 72A directing the coolant flow relative to a surface of a respective one of the battery cells 46 in accordance with one non-limiting aspect of the present disclosure. The battery cells 46 may correspond with battery cells 46 aligned within the same row such that a coolant inlet 86 may be used to direct the coolant through the spiral channels 72A from bottom to top of a first battery cell 46A, through a tunnel other construct 147 in the potting material to a second battery cell 46B, and then from top to bottom relative to the second battery cell 46B for exchange through a coolant outlet 88. FIG. 10 illustrates a perspective schematic view of the spiral channels 72A directing the coolant flow relative to a surface of a respective one of the battery cells 46 in accordance with one non-limiting aspect of the present disclosure.

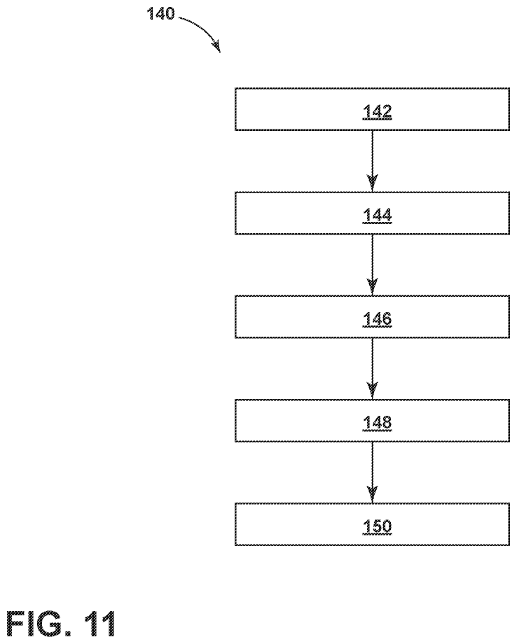

FIG. 11 illustrates a flowchart 140 of a method for manufacturing a battery module 44 in accordance with one non-limiting aspect of the present disclosure. Block 142 relates to a forming process whereby the preformed insert 68 may be formed. The forming process may include forming the preformed insert 68 such that the cell cavities 70 include an upper end, a lower end, and a middle portion between the upper and lower ends, with the upper and lower ends being narrower than the middle portions and the middle portions defining the coolant channels 72. The forming process may include forming the preformed insert 68C such that the battery cells 46 are arranged into a plurality of rows and the middle portions of the cavities 70 in each respective row fluidly interconnect with each other to define the coolant channels 72. The forming process may include forming the preformed insert 68 out of a thermally conductive material having a closed-cell foam structure. Block 144 relates a process for receiving and/or manufacturing a cell holder 50. Block 146 relates a process for receiving a plurality of battery cells 46. Block 148 relates to an assembly process for positioning a preformed insert 68 within the cell holder 50 and thereafter or in concert therewith pressing fitting or otherwise inserting the battery cells 46 into a respective one of the cell cavities 70. The assembly process may optionally be performed by securing the battery cells 46 within the preformed insert 68 and securing the preformed insert 68 within the cell holder 50 without use of a poured epoxy or a fluid adhesive.

As supported above, the present disclosure relates to a preformed cell-to-cell barrier potting material molded with built-in channels having active and/or passive flow control valves that provide directed cooling function for cells within battery module. The cell-to-cell barrier material may be formed as a part that can be assembled during battery module manufacturing to reduce manufacturing cost and cycle time by eliminating need for injection machines, inventory for potting cure time in assembly line, etc. The potting material may be formed with built-in channels for dielectric coolant flow to enable immersion cooling without a mass penalty of large coolant volume within the battery module. The potting material may be a preformed closed-cell foam material that provides thermal and electrical barrier between cells. The potting material may be shaped to enclose coolant flow channels that replace cold plate and/or cooling ribbons and interface directly with rest of the cooling system (pumps, filters, hoses, heat exchangers). The potting material may be shaped to form cavities for receiving battery cells and/or other types have energy cells having cylindrical, prismatic, pouch, or other shapes and/or sizes, with coolant channels shaped relative thereto. Sensors and flow control valves (either molded-in into the potting material at key locations or placed outside) may be used to provide temperature information about cells and coolant, and direct coolant to hottest cells. Coolant container plates may be used to seal the coolant within the cell holder, cool cells and busbars, and include pressure release valves to evacuate gases released during thermal event. Coolant channels with passive bimetallic strip valves may act as flow diverters along the entire length of the channel and may be molded into preformed potting and control flow (hotter cells get more flow as valves open the channels while cooler cells get less flow as valves partially close the channels). Flow to different sections of the coolant channels may be actively controlled at the inlet manifold via active flow control valve. The flow control valve may operate according to logic based on information from temperature sensors, optionally with the flow control valve redirecting more coolant flow to hotter parts of the module and/or away from the cooler parts of the module.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A battery module, comprising:
a plurality of battery cells configured for storing and supplying electrical power;
a cell holder configured for supporting the battery cells;
a preformed insert disposed relative to the cell holder and the battery cells, the preformed insert including a potting material shaped to define a plurality of coolant channels for the battery cells; and
a flow control system operable for controlling a coolant flow through the coolant channels.

2. The battery module according to claim 1, wherein
the flow control system includes a plurality of flow diverters disposed within the potting material, wherein the flow diverters are configured for metering the coolant flow through a respective one of the coolant channels.

3. The battery module according to claim 2, wherein
the flow diverters are configured for contracting from a nominal state to a smaller state in response to a coolant temperature of the coolant flow thereat surpassing a nominal temperature threshold.

4. The battery module according to claim 3, wherein
the flow diverters are configured for contracting to a minimal state smaller than the nominal state in response to a coolant temperature thereat surpassing the nominal temperature threshold by a predefined amount.

5. The battery module according to claim 4, wherein
the nominal state results in the flow diverters obstructing a greater portion of the coolant channels than when in the minimal state such that the nominal state restricts the coolant flow more than the minimal state.

6. The battery module according to claim 1, wherein:
the preformed insert includes a plurality of cell cavities fluidly interconnected with the coolant channels, wherein the cell cavities are shaped within the potting material to receive a respective one of the battery cells.

7. The battery module according to claim 6, wherein
the coolant channels are formed with a spiral shape around the cell cavities, wherein the spiral shape directs the coolant flow in a circular manner from top to bottom or from bottom to top of a respective one of the cell cavities.

8. The battery module according to claim 1, wherein
the flow control system includes a coolant container configured for enclosing the preformed insert and the battery cells within a sealed enclosure, wherein the sealed enclosure is operable for directing the coolant flow through the coolant channels and around the battery cells to provide immersive cooling.

9. The battery module according to claim 8, wherein
the coolant container includes a pressure release valve configured for releasing the coolant flow to an exterior of the sealed enclosure in response to a pressure within the sealed enclosure surpassing a pressure threshold.

10. The battery module according to claim 1, wherein:
the preformed insert includes a plurality of thermal channels for the battery cells, wherein the thermal channels are configured for retaining a thermal fluid separately from the coolant flow when a coolant temperature of the coolant flow is less than a thermal threshold and for releasing the thermal fluid into the coolant flow when the coolant temperature surpasses the thermal threshold.

11. The battery module according to claim 1, wherein:
the flow control system includes a flow manifold operable for directing a coolant input having a coolant to the coolant channels to produce the coolant flow therethrough.

12. The battery module according to claim 11, wherein:
the flow control system includes an input and an output for each respective one of the coolant channels and a flow director operable for selectively metering the coolant through the inputs and outputs, and thereby, the coolant flow through the respective coolant channel.

13. The battery module according to claim 12, wherein:
the flow control system includes a plurality of temperature sensors disposed relative to the battery cells and/or the coolant channels; and
the flow director is operable for metering the coolant based on temperatures measured with the temperature sensors.

14. A battery module, comprising:
a plurality of battery cells configured for storing and supplying electrical power;
a preformed insert including a potting material shaped to define a plurality of cell cavities and a plurality of cooling channels, wherein the cell cavities are configured for retaining the battery cells and the cooling channels are configured for directing a coolant flow relative to the cell cavities;
a coolant container configured for enclosing the preformed insert and the battery cells within a sealed enclosure; and
a flow control system operable for cycling a coolant through the coolant channels and the coolant container to immersively cool the battery cells.

15. The battery module according to claim 14, wherein
the immersive flow control system includes a plurality of flow diverters disposed within the coolant channels, wherein the flow diverters are configured for expanding and contracting based on a coolant temperature of the coolant flow thereat.

16. The battery module according to claim 15, wherein:
the flow diverters are configured for contracting from a nominal state to a minimal state in response to a coolant temperature thereat surpassing a nominal temperature threshold by a predefined amount, wherein the nominal state results in the flow diverters obstructing a greater portion of the coolant channels than when in the minimal state.

17. The battery module according to claim 14, wherein
the coolant channels are formed with a spiral shape that directs the coolant flow in a circular manner from top to bottom or from bottom to top of a respective one of the cell cavities.

18. A vehicle, comprising:
an electric motor configured for converting electrical power to mechanical power suitable for use in propelling the vehicle; and
a rechargeable energy storage system (RESS) having one or more energy modules configured for storing and supplying the electrical power, wherein the energy modules respectively include:
a plurality of energy cells configured for storing and supplying electrical power;
a preformed insert including a potting material shaped to define a plurality of cell cavities and a plurality of cooling channels, wherein the cell cavities are configured for receiving the energy cells and the cooling channels are configured for directing a coolant flow relative to the cell cavities;
a coolant container configured for enclosing the preformed insert and the energy cells within a sealed enclosure; and
an immersive flow control system operable for cycling a coolant through the coolant channels and the coolant container to immersively cool the energy cells.

19. The vehicle according to claim 18, wherein:
the energy modules each include a busbar configured for electrically interconnecting the energy cells thereof, wherein the busbars respectively connect to a portion of the energy cells above the preformed insert and within the coolant container such that the busbars are immersively cooled.

20. The vehicle according to claim 19, wherein:
the immersive flow control system includes a plurality of flow diverters disposed within the coolant channels, wherein the flow diverters are configured for expanding and contracting based on a coolant temperature of the coolant flow thereat such that the flow diverters contract from a nominal state to a minimal state in response to a coolant temperature thereat surpassing a nominal temperature threshold by a predefined amount and thereafter expand back to the nominal state upon the coolant temperature dropping below the nominal temperature threshold.
